(19) United States
(12) Patent Application Publication
(10) Pub. No.: US 2016/0319978 A1
(43) Pub. Date: Nov. 3, 2016

(54) DEPLOYABLE PLUG SYSTEM

(71) Applicant: James Richard CHAMPLONE, Medicine Hat (CA)

(72) Inventor: James Richard CHAMPLONE, Medicine Hat (CA)

(21) Appl. No.: 15/208,235

(22) Filed: Jul. 12, 2016

Related U.S. Application Data
(63) Continuation-in-part of application No. 14/689,809, filed on Apr. 17, 2015, now Pat. No. 9,416,908.
Application No. 14/689,809 is a continuation of application No. PCT/CA2015/000119, filed on Feb. 25, 2015.
Application No. PCT/CA2015/000119 is a continuation-in-part of application No. 14/319,623, filed on Jun. 30, 2014, now Pat. No. 9,016,321.
(60) Provisional application No. 61/944,822, filed on Feb. 26, 2014.

(30) Foreign Application Priority Data
Dec. 30, 2014 (CA) 2876710

(51) Int. Cl. F16L 55/134; F16L 55/11

(52) U.S. Cl. CPC F16L 55/134; F16L 55/1141

(57) ABSTRACT

A deployable plug system comprises a handle assembly comprising a handle assembly conduit and a gas control valve configured to receive pressurized gas from a source of pressurized gas and to control flow of gas from the source of pressurized gas to the handle assembly conduit. The deployable plug system further comprises a bladder assembly comprising an inflatable bladder and a unitary check valve assembly configured to be coupled detachably to the handle assembly conduit to receive the flow of gas from the source of pressurized gas. The unitary check valve assembly comprises a one-way check valve that allows pressurized gas from the handle assembly conduit to enter the bladder when the check valve assembly is coupled detachably to the handle assembly conduit but that does not allow gas to leave the bladder. The unitary check valve assembly comprises a relief valve to enable pressurized gas to escape the bladder.

### RELATED APPLICATIONS

This application is a continuation-in-part of U.S. patent application Ser. No. 14/689,809, which was filed Apr. 17, 2015, and which is a continuation of PCT International Patent Application No. PCT/CA2015/000119, which was filed in the Canadian Receiving Office on

Feb. 25, 2015. PCT International Patent Application No. PCT/CA2015/000119 claims the benefit of and priority to U.S. Provisional Patent Application No. 61/944,822, which was filed Feb. 26, 2014, is a continuation-in-part of U.S. patent application Ser. No. 14/319,623, which was filed Jun. 30, 2014, and claims the benefit of and priority to Canadian Patent Application No. 2,876,710, which was filed on Dec. 30, 2014. The entire disclosures of U.S. patent application Ser. No. 14/689,809, PCT International Patent Application No. PCT/CA2015/000119, U.S. Provisional Patent Application No. 61/944,822, U.S. patent application Ser. No. 14/319,623, and Canadian Patent Application No. 2,876,710 are hereby incorporated herein by reference.

### FIELD

Embodiments of the present invention may relate to environmental remediation devices. For example, embodiments of the present invention may include plugs having inflatable bladders that may seal openings after a hazardous material spill.

### BACKGROUND

Bodies of water are highly vulnerable to the detrimental effects of exposure to oil and other hazardous chemical spills. While highly publicized hazardous chemical spills are usually associated with chemical spills into large bodies of water such as lakes or oceans, smaller spills occur far more frequently at locations such as drilling sites, factories, and tanker truck accidents. Such smaller hazardous chemical spills can quickly travel along roadside ditches into culverts and streams and from there into adjacent water supplies to cause even more damage and destruction.

Unfortunately, there are surprisingly few ways to stop or control hazardous chemical spills from traveling along ditches and culverts. Often, spilled hazardous chemicals disperse from a spill site before remediation efforts can be implemented. Accordingly, there exists a need for devices by which oil and other chemical spills can be prevented from dispersing to enable remediation efforts to be taken. In particular, a new system that contains and controls oil and other hazardous chemicals spills along culverts and other pipes would be beneficial. Ideally such a system would provide a quick, easy, and effective approach to containing oil and other hazardous chemicals spills to enable remediation. Preferably such a system could be quickly installed safely and efficiently by one man. In practice a rugged, reusable system would be particularly beneficial.

### SUMMARY

Embodiments of the present invention include devices by which oil and other chemical spills can be prevented from dispersing to enable remediation efforts to be taken. In particular, embodiments of the present invention may contain and control oil and other hazardous chemicals spills along culverts to enable remediation.

According to one embodiment, there is disclosed a deployable plug system, comprising: an elongated handle assembly having a hollow conduit, a distal end with a conduit connector in fluid communication with the conduit and a hinge assembly having a handle mounting body, and a proximal end, wherein a gas control valve is affixed to the handle assembly at the proximal end, and wherein the gas control valve is configured to receive pressurized gas from a source of pressurized gas, the gas control valve further including a valve trigger which selectively applies pressurized gas from the source of pressurized gas to the conduit; and a bladder assembly having a bladder mounting body removably connectable to the handle mounting body, a bladder attached to the bladder mounting body, a check valve assembly for allowing pressurized gas from the conduit to enter the bladder, and a check valve assembly connector that selectively connects the check valve assembly to the conduit connector.

In some embodiments, the conduit connector is a junction block comprising a block.

In some embodiments, the block has a slot that extends along the block from a front opening, and the handle assembly includes a gas aperture that passes from the conduit into the slot.

In some embodiments, the check valve assembly connector includes a hose that selectively connects the check valve to the junction block to communicate pressurized gas from the conduit to the bladder.

In some embodiments, the hose selectively connects to the junction block using a disc-shaped sealing ring which slides into the slot.

In some embodiments, the hose connects to the sealing ring and forms a seal with the junction block when the hose fits over the gas aperture.

In some embodiments, the deployable plug system further includes a release rod slidingly affixed to the handle assembly which may extend into the junction block.

In some embodiments, the release rod can push the sealing ring out of the slot.

In some embodiments, the check valve assembly connects to the hose using a barbed fitting.

In some embodiments, the source of pressurized gas is a removable compressed-gas canister that can be retained by the gas control valve.

In some embodiments, the compressed-gas canister is threadably connectable to the gas control valve.

In some embodiments, the gas canister contains compressed CO₂.

In some embodiments, the gas canister contains compressed N₂.

In some embodiments, the check valve assembly includes a one way check valve that allows gas to enter but not leave the bladder.

In some embodiments, the check valve assembly further includes a relief valve to enable pressurized gas to escape the bladder.

In some embodiments, the hinge assembly includes a fastener assembly that locks the hinge assembly relative to the handle assembly.

In some embodiments, the handle mounting body and the bladder mounting body include interlocking features.

In some embodiments, the handle mounting body is a handle mounting plate and the bladder mounting body is a bladder mounting plate.

In some embodiments, the handle mounting plate includes a male feature, the bladder mounting plate includes a female feature, and the handle mounting plate can be locked into the bladder mounting plate by moving up and released by moving down.

In some embodiments, the male feature has a “T” cross-sectioned.

In some embodiments, the handle assembly has a handle on the proximal end of the handle assembly.

In some embodiments, the valve trigger is disposed adjacent the handle.

In some embodiments, the handle includes grip features.

In some embodiments, the bladder expands in length and width when filled with pressurized gas.

In some embodiments, the bladder includes ribs.

In some embodiments, the bladder is comprised of rubber.

In some embodiments, the handle mounting body and the bladder mounting body are configured to permit the handle assembly to be attached to and detached from the bladder assembly by sliding the distal end of the handle assembly relative to the bladder assembly.

In some embodiments, the conduit connector and the check valve assembly connector are configured to permit the conduit to be attached to and detached from the check valve assembly by sliding the distal end of the handle assembly relative to the bladder assembly.

According to another embodiment, there is disclosed a deployable plug system comprising: a handle assembly comprising a handle assembly conduit and a gas control valve, wherein the gas control valve is configured to receive pressurized gas from a source of pressurized gas and to control flow of gas from the source of pressurized gas to the handle assembly conduit; and a bladder assembly comprising an inflatable bladder and a unitary check valve assembly, wherein the unitary check valve assembly is configured to be coupled detachably to the handle assembly conduit to receive the flow of gas from the source of pressurized gas when the check valve assembly is coupled detachably to the handle assembly conduit, wherein the unitary check valve assembly comprises a one-way check valve that allows pressurized gas from the handle assembly conduit to enter the bladder when the check valve assembly is coupled detachably to the handle assembly conduit but that does not allow gas to leave the bladder, and wherein the unitary check valve assembly comprises a relief valve to enable pressurized gas to escape the bladder.

In some embodiments: the handle assembly further comprises a handle assembly conduit connector in fluid communication with the handle assembly conduit; and the bladder assembly further comprises a check valve assembly connector selectively connectable to the handle assembly conduit connector to couple detachably the check valve assembly to the handle assembly conduit.

In some embodiments: the handle assembly conduit connector comprises a slot and an aperture in fluid communication with the handle assembly conduit; and the check valve assembly connector comprises a hose selectively connectable to the slot to communicate the pressurized gas from the handle assembly conduit to the bladder when the hose is coupled detachably to the slot with the hose in fluid communication with the aperture.

In some embodiments, the hose comprises a sealing body sized to slide into the slot and form a seal surrounding the aperture when the hose is in fluid communication with the aperture.

In some embodiments, the sealing body is a sealing ring.

In some embodiments, the system further comprises a release rod slidingly affixed to the handle assembly and configured to push the sealing body out of the slot in response to sliding relative to the handle assembly.

In some embodiments, the handle assembly conduit connector and the check valve assembly connector are configured to permit the conduit to be attached to and detached from the check valve assembly by sliding the conduit connector relative to the check valve assembly.

In some embodiments, the handle assembly and the bladder assembly comprise interlocking features, separate from the handle assembly conduit connector and the check valve assembly connector, that hold in relative position independently of handle assembly conduit connector and of check valve assembly connector

In some embodiments, the interlocking features are configured to permit the handle assembly and the bladder assembly to be attached to and detached from each other by sliding one of the handle assembly and the bladder assembly relative to the other of the handle assembly and the bladder assembly.

In some embodiments, the system further comprises a release rod comprising a rod trigger that, when pressed, detaches the check valve assembly from the conduit connector.

In some embodiments, the handle assembly conduit connector and the check valve assembly connector form a fluid conduit coupling.

In some embodiments, the fluid conduit coupling is configured to couple detachably the check valve assembly connector and the handle assembly conduit connector in response to sliding one of the handle assembly and the bladder assembly relative to the other of the handle assembly and the bladder assembly.

In some embodiments, the fluid conduit coupling is configured to couple detachably the check valve assembly connector and the handle assembly conduit connector in response to sliding one of the handle assembly and the bladder assembly relative to the other of the handle assembly and the bladder assembly in a direction generally parallel to a longitudinal axis of the handle assembly conduit.

In some embodiments, the fluid conduit coupling comprises a slidable release body configured to detach the check valve assembly connector and the handle assembly conduit connector from each other in response to sliding the slidable release body.

In some embodiments, the slidable release body is slidable in a direction generally parallel to a longitudinal axis of the handle assembly conduit to detach the check valve assembly connector and the handle assembly conduit connector from each other.

In some embodiments, the fluid conduit coupling is configured to hold the bladder assembly in a defined position relative to the handle assembly and independently of any other connectors when the check valve assembly connector is coupled detachably to the handle assembly conduit connector.

In some embodiments, the handle assembly further comprises a valve trigger configured to control the gas control valve to control the flow of gas from the source of pressurized gas to the handle assembly conduit.

In some embodiments, the one-way check valve and the relief valve are in fluid communication with the bladder through a common fluid bladder conduit.

In some embodiments, the source of pressurized gas is a pressurized-gas canister that can be coupled detachably to the handle assembly.

In some embodiments, the bladder is configured to expand in length and width when filled with pressurized gas.

A deployable culvert plug system according to another embodiment includes an elongated handle assembly having a hollow conduit, a distal end with a junction block in fluid communication with said conduit and a hinge assembly having a handle mounting plate, and a proximal end having a handle and a gas control valve for retaining a removable gas cylinder containing a pressurized gas. The gas control valve further includes a valve trigger which selectively applies pressurized gas to the conduit. The deployable culvert plug system further includes a bladder assembly having a bladder mounting plate that is removably connected to the handle mounting plate, a bladder that is attached to the bladder mounting plate, a check valve assembly for allowing pressurized gas to enter the bladder, and a hose that selectively connects the check valve assembly to the junction block. In use the handle assembly enables a user to deploy the bladder and the valve trigger selectively applies pressurized gas from a removable gas cylinder through the conduit, through the hose, through the check valve and into the bladder.

In some embodiments, the removable gas cylinder threads onto the gas control valve and the pressurized gas is CO₂. In some embodiments, the check valve assembly connects to the hose using a barbed fitting and the check valve assembly includes a check valve that allows gas to enter but not leave the bladder. The check valve assembly in some embodiments further includes a relief valve to enable pressurized gas to escape from the bladder.

In some embodiments, the hinge assembly includes a fastener assembly that locks the hinge assembly relative to the handle assembly and the handle mounting plate and the bladder mounting plate include interlocking features. The handle mounting plate may include a male feature, the bladder mounting plate may include a female feature, and the handle mounting plate can be locked into the bladder mounting plate by moving up and released by moving down. The male feature may be “T” cross-sectioned. The valve trigger may be disposed adjacent said handle and the handle may include grip features.

In some embodiments, the junction block is comprised of a block having a slot that extends along the block from a front opening, and the handle assembly includes a gas aperture that passes from the conduit into the slot. The hose in some embodiments connects to the junction block using a disc-shaped sealing ring which slides into the slot. The sealing ring in some embodiments connects to the hose and forms a seal with the junction block when the hose fits over the gas aperture. In some embodiments, a release rod is slidingly affixed to the handle assembly and extends into the junction block. That release rod may push the sealing ring out of the slot.

In some embodiments, the bladder expands in length and width when filled with pressurized gas. In some embodiments, the bladder includes ribs and is comprised of rubber.

### BRIEF DESCRIPTION OF THE DRAWINGS

Some potential advantages and features of embodiments of the present invention will become better understood with reference to the following more detailed description and claims taken in conjunction with the accompanying drawings in which like elements are identified with like symbols and in which:

FIG. 1 is an environmental view of a deployable plug system 10 according to an embodiment of the present invention;

FIG. 2 is an exploded view of the deployable plug system 10 shown in FIG. 1;

FIG. 3 is a perspective view of parts of a bladder assembly 20 and handle assembly 60 used in the deployable plug system 10 shown in FIGS. 1 and 2;

FIG. 4 is a close-up perspective view of a hose junction block 88 used in the deployable plug system 10 shown in FIGS. 1 and 2;

FIG. 5 is a sectional view of the hose junction block 88 taken along section line A-A of FIG. 4;

FIG. 6 is a perspective view of the proximal end of the handle assembly 60; and,

FIG. 7 is a perspective view of a deployable plug system according to another embodiment of the present invention.

### DESCRIPTIVE KEY

10 deployable plug system

20 bladder assembly

22 bladder

24 ribs

26 bladder mounting plate

27 female locking feature

30 check valve

31 relief valve

32 first hose

34 sealing ring

60 handle assembly

62 handle

63 conduit

66 grip

67 finger relief

73 gas control valve

75 valve trigger

77 female threads

78 gas canister

79 male threads

80 guard cylinder

82 cylinder aperture

84 hose release rod

85 rod brackets

86 rod trigger

88 hose junction block

89 slot

90 front opening

91 gas aperture

92 rod aperture

100 handle mounting plate

102 hinge assembly

103 fastener assembly

106 male locking features

150 culvert pipe

200 deployable plug system

202 handle assembly

204 bladder assembly

206 handle

208 trigger

210 pressurized gas source connector

212 handle assembly conduit

214 gas control valve

216 handle assembly conduit connector

218 fluid conduit coupling

220 bladder

222 check valve assembly

224 relief valve

226 check valve assembly connector

228 slidable release body

230 fluid bladder conduit

### DETAILED DESCRIPTION

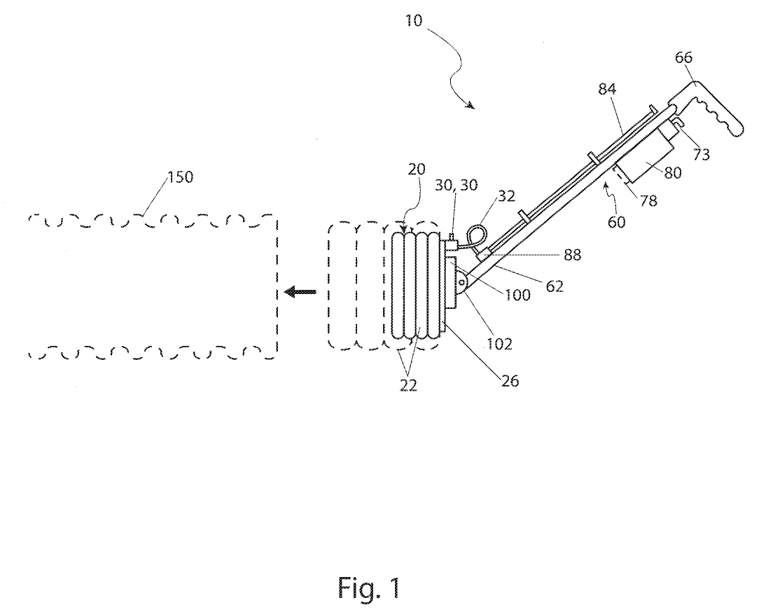

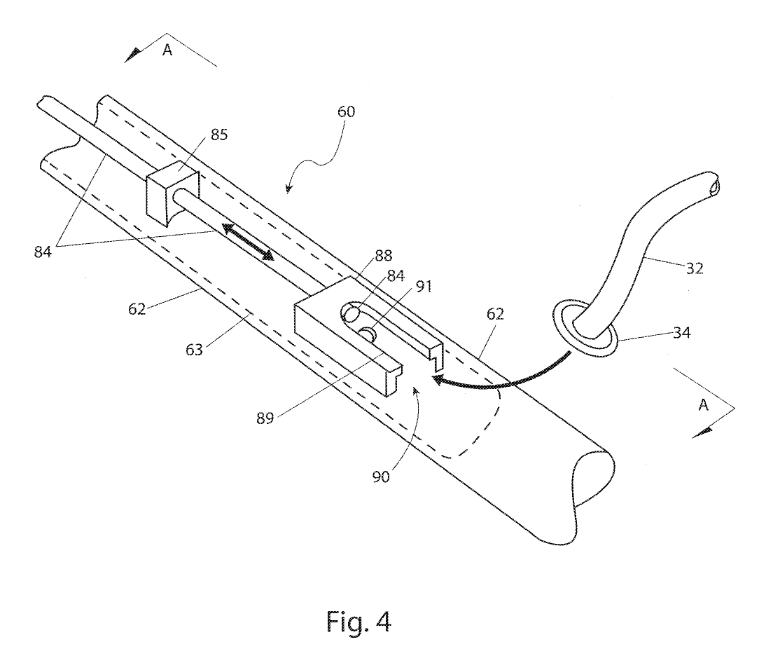

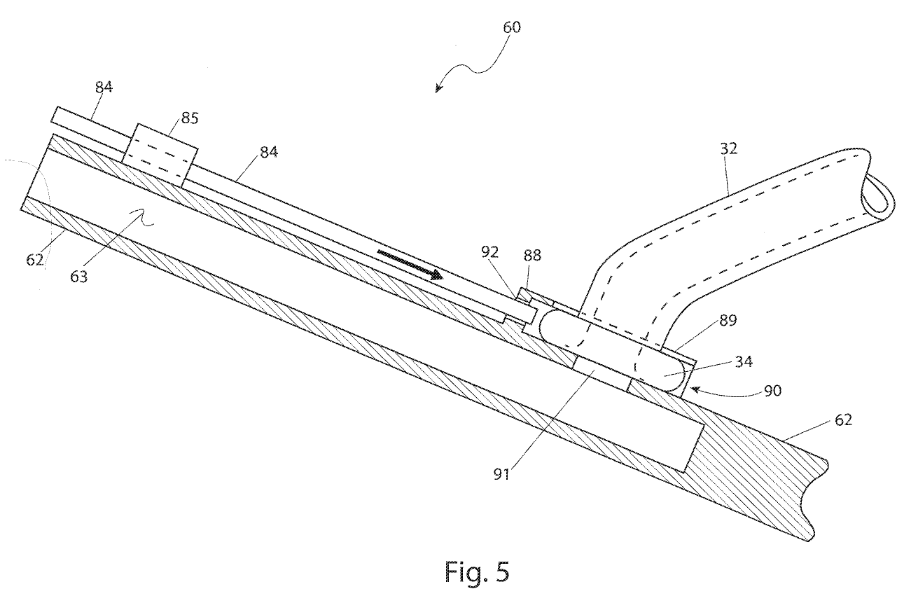

An embodiment of the present invention is depicted within FIGS. 1-6. However, embodiments of the invention are not limited to what is specifically illustrated and described. A person skilled in the art will appreciate that many other embodiments of the invention are possible without deviating from the basic concept of the invention. Any such work around also falls with the scope of this invention.

The terms “a” and “an” herein do not denote a limitation of quantity, but rather denote the presence of at least one of the referenced items. In addition, unless otherwise denoted all directional signals such as up, down, left, right, inside, outside are taken relative to the illustration shown in FIG. 1.

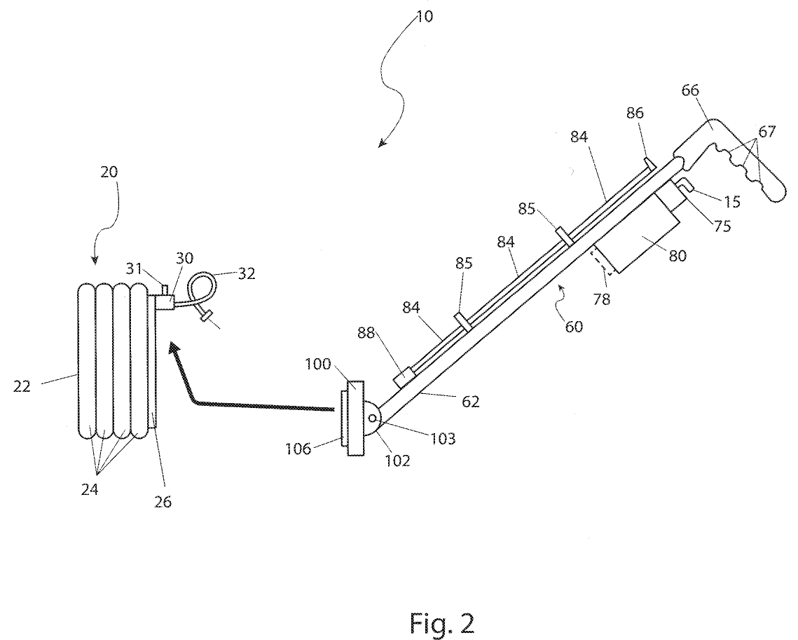

FIGS. 1 and 2 respectively illustrate environmental and exploded views of a deployable plug system 10 according to an embodiment of the present invention. When installed the deployable plug system 10 prevents fluid flow into and out of a culvert pipe 150 after a hazardous material spill, although alternative embodiments may prevent fluid flow into or out of other openings such as openings of manholes, catch basins, or other pipes for example. As shown in FIGS. 1 and 2 the deployable plug system 10 includes a bladder assembly 20 that is removably attached to a handle assembly 60. As described in more detail subsequently the handle assembly 60 enables a user to stand above and beside the culvert pipe 150 while positioning the bladder assembly 20 into the opening of the culvert pipe 150.

Referring now to FIGS. 1, 2, and 4-6 as required, the handle assembly 60 is configured to receive pressurized gas from a pressurized gas source, which in the embodiment shown is a threaded removable pressurized gas canister 78 in a threaded gas control valve 73. The gas canister 78 may include a pressure regulator to regulate pressure of pressurized gas released from the gas canister 78. Also, the gas canister 78 may contain compressed non-flammable, non-poisonous, inert, and environmentally-friendly gas, such as compressed carbon dioxide (“CO₂”) or compressed nitrogen (“N₂”) gas for example, and some or all of the compressed gas may be liquefied. In other embodiments, the handle assembly 60 may retain other gas cylinders, canisters, or containers, or may receive pressurized gas from still other pressurized gas sources. Also, in other embodiments, the compressed gas may include other non- flammable, non-poisonous, inert, and environmentally-friendly gases such as air, argon, helium, or neon, or any combination of two or more of carbon dioxide, nitrogen, air, argon, helium, and neon. Compressed gases are available from various commercial sources, such as Matheson and Air Liquide for example, and costs and potential health hazards may be considerations when choosing a gas or mixture of gasses.

When a user operates a valve trigger 75 of the gas control valve 73 pressurized gas in the gas canister 78 passes down a hollow center conduit 63 of the handle assembly 60 and into the bladder assembly 20. This is described in more detail below. As the gas fills the bladder assembly 20 a bladder 22 expands in length and width. If the bladder 22 is inside the culvert pipe 150 the bladder 22 expands against the wall of the culvert pipe 150 to form a seal which prevents water as well as spilled hazardous materials from entering or leaving the culvert pipe 150. As a person skilled in the art will appreciate, the material of the bladder 22 and of the wall of the culvert pipe 150 will have a coefficient of friction such that frictional force between the bladder 22 and the wall of the culvert pipe 150 will generally be proportional to the outward force that the bladder 22 exerts on the wall of the culvert pipe 150, and the outward force that the bladder 22 exerts on the wall of the culvert pipe 150 will depend on the pressure of gas in the bladder 22. Therefore, in general, the pressure of the pressurized gas from the gas canister 78 should be sufficient to cause the bladder 22 to exert a sufficient outward force on the wall of the culvert pipe 150 to maintain the seal between the bladder 22 and the wall of the culvert pipe 150 when under external pressure from water or other substance or substances that the bladder 22 blocks from entering or leaving the culvert pipe 150.

Referring now primarily to FIGS. 1-3, the bladder assembly 20 includes a unidirectional check valve 30 that is integral or attached to a bladder mounting body, which in the embodiment shown is a bladder mounting plate 26. The check valve 30 allows gas to enter but not leave the bladder 22. The bladder assembly 20 also includes an integral “poppet-type” relief valve 31 that enables gas inside the bladder 22 to be let out. As shown in FIGS. 1-3, the bladder assembly 20 the embodiment shown includes a unitary check valve assembly including the check valve 30 and the relief valve 31. The handle assembly 60 is attachable to and detachable from the bladder mounting plate 26 (as is discussed in more detail subsequently) to enable the inflated bladder assembly 20 to remain in the culvert pipe 150 while the handle assembly 60 is detached. When remediation is complete, the handle assembly 60 is re-attached to the bladder assembly 20 which is then deflated by depressing the relief valve 31. When the bladder assembly 20 is sufficiently deflated it can be removed from the culvert pipe 150 to allow water to again flow through the culvert pipe 150.

It is envisioned that the bladder assembly 20 and the bladder 22 would be made available in multiple sizes and shapes to fit corresponding sizes of culvert pipes or other openings such as openings of manholes, catch basins, or other pipes for example. In fact it is envisioned that the bladder assembly 20 and its bladder 22 can be used for applications that range from small culverts under residential driveways to those through highway bypasses. Furthermore, it is also envisioned that the deployable plug system 10 could be used to temporarily seal manholes and other similar structures, or more generally various different pipes for example. Thus the specific application of sealing culvert pipes 150 should not necessarily be interpreted as a limiting factor of the deployable plug system 10.

Referring once again to FIGS. 1 and 2, the handle assembly 60 includes a hinge assembly 102 that enables adjustment of the relative angle between the elongation axis of the handle assembly 60 and the bladder assembly 20. The hinge assembly 102 enables a user to be safely positioned along an embankment or other stable surface adjacent the culvert pipe 150 while installing the deployable plug system 10 into the culvert pipe 150. The hinge assembly 102 is envisioned as having a pivot that is integrally-molded or otherwise affixed to a handle mounting body, which in the embodiment shown is a handle mounting plate 100, such that the handle mounting plate 100 is pivotally connected to the handle 62. Turning now specifically to FIG. 2, the handle mounting plate 100 is connected to the hinge assembly 102 by a fastener assembly 103 which selectively locks the hinge assembly 102 relative to the handle assembly 60. The fastener assembly 103 can be as simple as a bolt and a nut. In use, the handle mounting plate 100 is rotated by the user to a desired angle with the handle 62 and is then locked in position by the user tightening the fastener assembly 103. This rigidly connects the handle mounting plate 100 in place to allow it to be used to insert the bladder assembly 20 into the culvert pipe 150.

Except for the bladder 22 (which is rubber in the embodiment shown) the other major components of the deployable plug system 10 are envisioned as being made of economic and light-weight plastic materials. However, other materials such as stainless steel, aluminum, and the like may also be used with benefit based upon a user's preference and the requirements of a particular remediation.

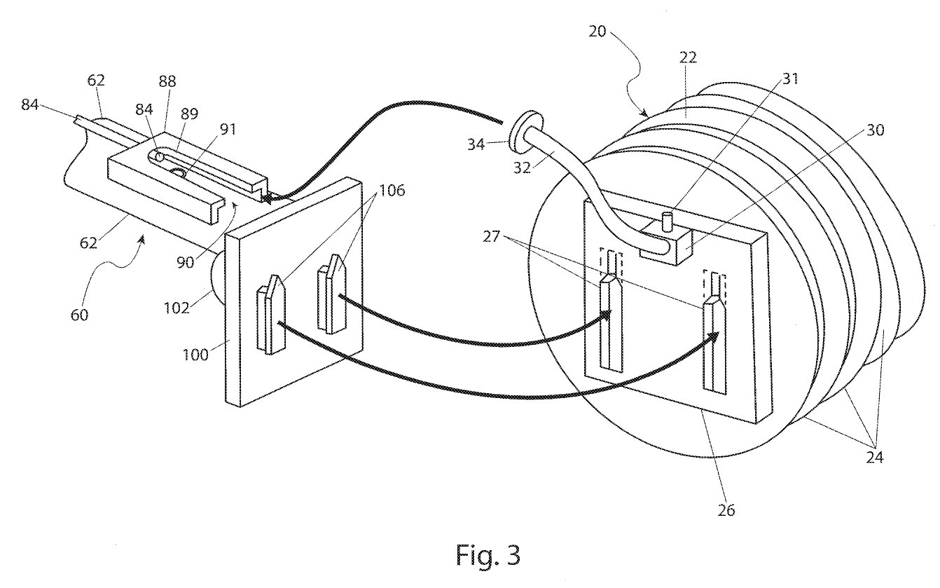

Refer now primarily to FIG. 3 for a perspective view of the bladder assembly 20 and the lower end of the handle assembly 60. As previously noted the bladder assembly 20 includes the bladder mounting plate 26 and the handle assembly 60 includes the handle mounting plate 100. In practice the bladder mounting plate 26 is adhesively or otherwise securely affixed to one end of the bladder 22. The handle mounting plate 100 is attached to the handle assembly 60.

Still referring to FIG. 3, the bladder mounting plate 26 includes a pair of female locking features 27 and the handle mounting plate 100 includes a pair of interlocking male locking features 106. The male locking features 106 are vertically parallel “T” cross-sectioned shapes that can be inserted into vertically parallel openings of the female locking features 27 in a tab-and-slot fashion. When inserted into the female locking features 27 the male locking features 106 can be slide upward to lock into place and then downward to release.

Still referring to FIG. 3, the bladder assembly 20 also includes a check valve assembly connector, which in the embodiment shown is a high-pressure hose 32, that connects to the check valve 30 via a barbed fitting or by another highly reliable leak-proof attachment. The check valve 30 is a one way valve that allows gas to enter the bladder 22 but prevents gas leakage when the handle assembly 60 is removed as is described subsequently. The hose 32 enables the gas to pass into the check valve 30 and thus into the bladder 22. Therefore, as shown in FIGS. 1-3, the unitary check valve assembly of the bladder assembly 20 of the embodiment shown (which includes the check valve 30 and the relief valve 31 as described above) is also configured to be coupled detachably to the conduit 63 to receive a flow of gas when the check valve assembly is coupled detachably to the conduit 63 as described below. The conduit 63 is part of the handle assembly 60 and therefore may also be referred to as a handle assembly conduit 63.

The bladder 22 is envisioned as being a generally cylinder-shaped structure made of a heavy-duty rubber that is capable of resisting damage from sharp features that might be found in the culvert pipe 150. The bladder 22 has an exterior surface made up of generally parallel semi-circular ribs 24 which when inflated expand in overall length and diameter. This causes the ribs 24 to align with internal radial features of the culvert pipe 150 to form a seal.

However, other embodiments may not include ribs 24. For example, bladders intended to seal smooth inner surfaces of pipes, manholes, or catch basins bladders may have a smooth surface to seal such smooth inner surfaces.

Still referring to FIG. 3, the hose 32 also connects to a conduit connector, which in the embodiment shown is a hose junction block 88 that is located near the distal end of the handle assembly 60. The hose junction block 88 is a boxlike structure integrally molded or otherwise permanently affixed to the handle assembly 60. The hose 32 connects to the hose junction block 88 using an integrally-molded disc-shaped sealing ring 34 which slides into a slot 89 of the hose junction block 88. The slot 89 extends between a rectangular front opening 90 to a circular rear rod aperture 92.

The slot 89 is dimensioned to receive the sealing ring 34 to form a seal. The front opening 90 is dimensioned to allow the sealing ring 34 to enter the slot 89. When fully inserted into the slot 89 the hose 32 and sealing ring 34 are located over a gas aperture 91 that passes through the conduit 63 of the handle 62 into the slot 89. This enables gas injected into the conduit 63 to pass into the first hose and then into the bladder assembly 20. Thus, the bladder assembly 20 and the handle assembly 60 are mechanically coupled together by the male locking features 106 and by the female locking features 27 and in fluid communications via the hose 32.

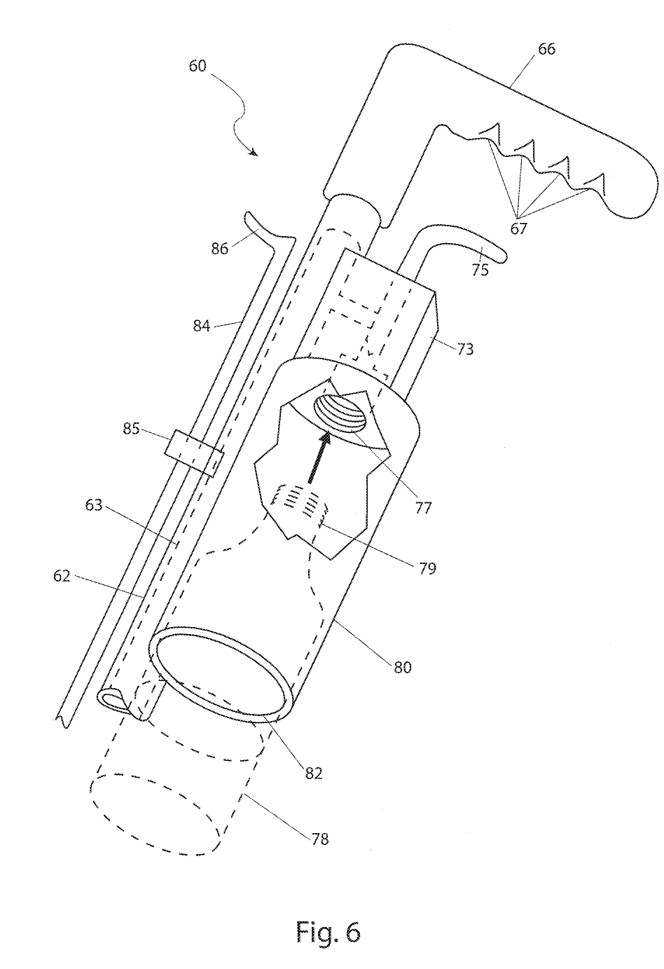

Turning back to FIGS. 1 and 2 as well as to FIG. 6, when the gas control valve 73 releases pressurized gas from the gas canister into the conduit 63 of the handle 62, that gas fills the conduit 63, passes through the gas aperture 91 into the hose 32, then passes through the check valve 30, and enters and inflates the bladder 22. In addition, the sealing ring 34 provides a gas tight seal between the hose 32 and the gas aperture 91 and hose junction block 88 while the check valve 30 only allows to enter but not leave the bladder 22.

The configuration of the hose junction block 88 with its slot 89 and the hose 32 with its sealing ring 34 enable a user to rapidly detach the hose 32 from the handle assembly 60. Referring now to FIGS. 1-5, to that end the handle assembly 60 includes a sliding hose release rod 84. That hose release rod 84 extends from near the top of the handle 62 into the rod aperture 92 of the hose junction block 88. The hose release rod 84 is held to the handle 62 using linearly aligned rod brackets 85.

The handle assembly 60 is detached from the hose 32 by the user pressing down on a rod trigger 86 of the hose release rod 84 (see FIG. 6). This moves the hose release rod 84 down, causing its lower end to slide through the rod aperture 92 to contact and push the sealing ring 34 down the slot 89 and out the front opening 90. The bladder mounting plate 26 and the handle mounting plate 100 can then be detached from each other by lowering and withdrawing the male locking features 106 from the female locking features 27. The handle assembly 60 is then fully disconnected from the bladder assembly 20 and may then be removed. More generally, in various embodiments such as those described herein, the handle assembly may be fully decoupled from the bladder assembly by sliding the distal end of the handle assembly relative to the bladder assembly to disconnect the handle mounting body (the handle mounting plate 100 in the embodiment shown) from the bladder mounting body (the bladder mounting plate 26 in the embodiment shown), and to disconnect the conduit connector (the hose junction block 88 in the embodiment shown) from the check valve assembly connector (the high-pressure hose 32 in the embodiment shown), which may facilitate decoupling the handle assembly from the bladder assembly when compared to other devices. In other embodiments, the distal end of the handle assembly may slide relative to the bladder assembly in directions other than in the embodiment shown.

The bladder assembly 20 can remain within the culvert pipe 150 until the remediation project is complete. When remediation is complete the handle assembly 60 is re-attached to the bladder assembly 20 by inserting the male locking features 106 into the female locking features 27 and then locking the male locking features 106 in place by sliding them upward. The bladder assembly 20 is then deflated by pushing down on the relief valve 31 until the bladder assembly 20 can be removed from the culvert pipe 150. Again, more generally in various embodiments such as those described herein, the handle assembly may be reattached to the bladder assembly to remove the bladder assembly from an opening by sliding the distal end of the handle assembly relative to the bladder assembly to connect the handle mounting body (the handle mounting plate 100 in the embodiment shown) from the bladder mounting body (the bladder mounting plate 26 in the embodiment shown), which may facilitate reattaching the handle assembly from the bladder assembly when compared to other devices. Again, in other embodiments, the distal end of the handle assembly may slide relative to the bladder assembly in directions other than in the embodiment shown.

FIG. 6 presents a more detailed view of the handle assembly 60 and its gas canister 78. The proximal end of the handle assembly 60 receives the gas canister 78. The handle assembly 60 includes a grip 66, the gas control valve 73, a spring-returned valve trigger 75, and a guard cylinder 80. The grip 66 enables the user to grasp the deployable plug system 10 securely while positioning the bladder assembly 20 within a culvert pipe 150. The grip 66 is envisioned as being made of a soft high-friction rubber or plastic material having a plurality of recessed finger reliefs 67 to improve gripping and manipulative control.

The gas control valve 73 is envisioned as being integrally-molded or otherwise affixed to the handle assembly 60 adjacent the grip 66. The gas control valve 73 regulates fluid communication into the conduit 63 of the handle 62. The gas control valve 73 is manually activated via the valve trigger 75 to enable gas in the gas canister 78 to be released and to flow into the conduit 63. The valve trigger 75 also closes the conduit 63 to prevent release of contained gas.

Still referring to FIG. 6, the gas control valve 73 includes female threads 77 and a guard cylinder 80. The guard cylinder 80 extends parallel to the handle 62 and has a cylinder aperture 82 that receives the gas canister 78. When inserting a gas canister 78 into the guard cylinder 80 male threads 79 of the gas canister 78 engage the female threads 77 of the gas control valve 73. The guard cylinder 80 covers most of the gas canister 78 but leaves the gas canister 78 with a protruding bottom that enables a user to grasp and rotate the gas canister 78 as required to thread into the gas control valve 73.

The gas canister 78 is envisioned as being a commercially-available product such as a twenty ounce (20 oz.) canister of compressed gas such as CO₂ or N₂, and the compressed gas may be in a gaseous or liquefied state, or both, or another type of gas cylinder or canister or other gas source that is capable of delivering a volume of gas sufficient to inflate the bladder 22. The gas canister 78 is envisioned as having an internal valve which is opened to deliver pressurized gas upon full engagement of the female 77 and male 79 threads. For larger bladders 22, the check valve 30 of the bladder assembly 20 and the valve trigger 75 of the gas control valve 73 enable a plurality of gas canisters 78 to be attached and emptied without loss of gas in the bladder 22 and conduit 63.

It is envisioned that other styles and configurations of other embodiments the present invention can be easily incorporated into the teachings of this disclosure. While only one particular configuration is shown and described that is for purposes of clarity and disclosure and not by way of limitation of scope.

Embodiments of the present invention can be utilized by the common user in a simple and effortless manner with little or no training. After initial purchase or acquisition the deployable plug system 10, it would be installed in a culvert tube 150 as indicated in FIG. 1. The method of preparing the deployable plug system 10 for use can be performing by: procuring a model of the deployable plug system 10 having a particular size and shape which corresponds to an intended culvert pipe 150 or other similar structure such as a manhole; evacuating gas from the bladder 22 using the relief valve 31 as and if required; joining the bladder assembly 20 to the handle assembly 60 by attaching the bladder and handle mounting plates 26, 100 together by inserting and lifting the male locking features 106 into the female locking features 27; inserting the sealing ring 34 of the hose 32 into the front opening 90 and up the slot 89 of the hose junction block 88 until the sealing ring 34 is centered over the gas aperture 91; inserting a gas canister 78 into the guard cylinder 80; and, engaging and tightening the male threads 79 of the gas canister 78 into the female threads 77 of the gas control valve 73. The deployable plug system 10 is then ready to plug a culvert pipe 150.

The method of installing the deployable plug system 10 within the culvert pipe 150 may be achieved by performing the following steps: safely positioning a user with respect to the culvert pipe 150; selecting a desired relative angle between the bladder assembly 20 and the handle assembly 60 by adjusting the hinge assembly 102 to the desired angle and then securing it in position by tightening the fastener assembly 103; inserting the deflated bladder 22 into the open end of the culvert pipe 150; inflating the bladder 22 by activating the valve trigger 75 of the gas control valve 73 to allow gas to flow through the handle 62 and into the bladder 22 until the bladder 22 is sufficiently expanded and sealed against the inner surfaces of the culvert pipe 150; releasing the valve trigger 75 to close the gas control valve 73; removing the handle assembly 60 from the bladder assembly 20 by detaching the hose 32 from the slot 89 by pushing the hose release rod 84 down; separating the female 27 and male 106 locking features of the bladder mounting plate 26 and the handle mounting plate 100, and, allowing the bladder assembly 20 to remain within the culvert pipe 150 to prevent flow of water and/or contaminants through the culvert pipe 150 until completion of a remediation project.

The method of removing the deployable plug system 10 from the culvert pipe 150 may be achieved by: attaching the handle assembly 60 to the bladder assembly 20 by engaging the female 27 and male 106 locking features of the bladder mounting plate 26 and the handle mounting plate 100 together; pressing the relief valve 31 to release gas from the bladder 22 to deflate the bladder 22; removing the bladder 22 from the culvert pipe 150 using the handle 62 and grip 66; stowing the deployable plug system 10 by removing the gas canister 78 from the guard cylinder 80; washing contaminants from the deployable plug system 10 using appropriate cleaning chemicals and equipment; removing the handle assembly 60 from the bladder assembly 20 as previously described; and deflating the bladder 22 using the relief valve 31 to enable compact storage of the deployable plug system 10 until needed again.

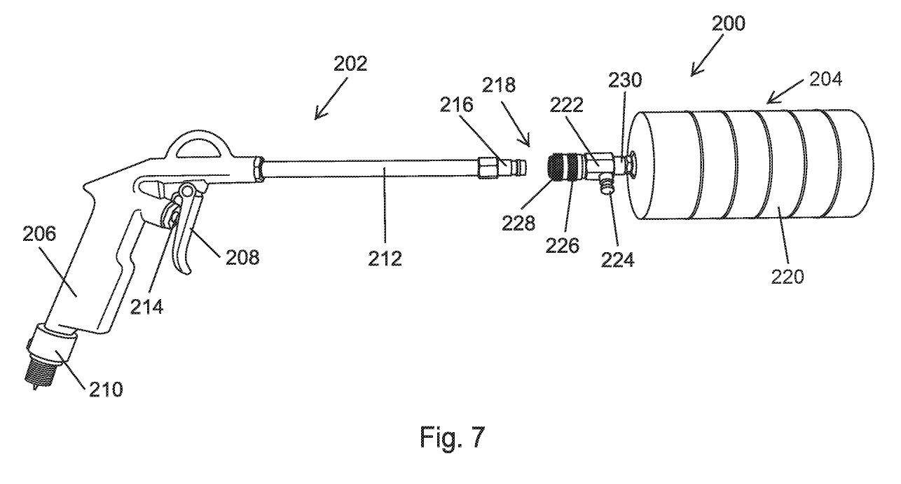

Referring to FIG. 7, a deployable plug system according to another embodiment is shown generally at 200 and includes a handle assembly shown generally at 202 and a bladder assembly shown generally at 204.

The handle assembly 202 includes a handle 206 sized to be gripped by a human hand, and a trigger 208 that is positioned near the handle 206 and pivotable relative to the handle 206 to permit one or more fingers of a human hand to actuate the trigger 208 when the human hand holds the handle 206. The handle assembly 202 also includes a pressurized gas source connector 210 configured to connect to a pressurized gas source, such as the gas canister 78 or any other source of pressurized gas such as a source of compressed carbon dioxide (“CO₂”) gas or compressed nitrogen (“N₂”) gas such as those described above, for example. The handle assembly 202 also includes a handle assembly conduit 212, and a gas control valve 214 positioned to be controlled by the trigger 208, and configured to receive pressurized gas from a source of pressurized gas connected to the pressurized gas source connector 210 and to control flow of gas from the source of pressurized gas to the handle assembly conduit 212.

A distal end of the handle assembly conduit 212 includes a handle assembly conduit connector 216 in fluid communication with the handle assembly conduit 212. In the embodiment shown, the handle assembly conduit connector 216 is a portion of a fluid conduit coupling shown generally at 218 and described further below.

The bladder assembly 204 includes an inflatable bladder 220. Like the bladder 22, the bladder 220 may be a generally cylinder-shaped structure, and may be made of a heavy-duty rubber that may be capable of resisting damage from sharp features that might be found in a culvert pipe or other structure. Also like the bladder 22, an exterior surface of the bladder 220 may include generally parallel semi-circular ribs, and when the bladder 220 is inflated, the bladder 220 may expand in overall length and diameter. The bladder 220 is therefore configured to expand in length and width when filled with pressurized gas. Such expansion of the bladder 220 may cause such ribs to align with internal radial features of a culvert pipe to form a seal, for example. However, other embodiments may not include such ribs. For example, bladders intended to seal smooth inner surfaces of pipes, manholes, or catch basins may have a smooth surface to seal such smooth inner surfaces.

The bladder assembly 204 also includes a unitary check valve assembly 222 including a one-way check valve and a relief valve 224. The check valve assembly 222 also includes a check valve assembly connector 226, which in the embodiment shown is another portion of the fluid conduit coupling 218 complementary to the handle assembly conduit connector 216 and selectively connectable to the handle assembly conduit connector 216 to couple detachably the check valve assembly 222 to the handle assembly conduit 212. The check valve assembly 222 is configured to be coupled detachably to the handle assembly conduit 212 in response to sliding one of the handle assembly 202 and the bladder assembly 204 relative to the other in a direction generally parallel to a longitudinal axis of the handle assembly conduit 212, for example by snapping or clicking to cause the fluid conduit coupling 218 to engage and to couple detachably the handle assembly conduit 212 to the check valve assembly 222.

In the embodiment shown, the check valve assembly connector 226 (and more generally the fluid conduit coupling 218) includes a slidable release body 228 that is slidable in a direction generally parallel to a longitudinal axis of the handle assembly conduit 212 to detach the check valve assembly connector 226 and the handle assembly conduit connector 216 from each other.

When the check valve assembly 222 is coupled detachably to the handle assembly conduit 212, the fluid conduit coupling 218 holds the bladder assembly 204 in a defined position relative to the handle assembly 202 and independently of any other connectors when the check valve assembly connector is coupled detachably to the handle assembly conduit connector. Therefore, in the embodiment shown, when the check valve assembly 222 is coupled detachably to the handle assembly conduit 212, the handle assembly 202 may be used to position the bladder assembly 204 in a culvert pipe, catch basin, pipe, or other opening, for example, without requiring separate connectors (such as interlocking features 27 and 106, for example).

Further, when the check valve assembly 222 is coupled detachably to the handle assembly conduit 212, the check valve assembly 222 is configured to receive, from the handle assembly conduit 212, a flow of gas from a source of pressurized gas connected to the pressurized gas source connector 210, and the one-way check valve of the check valve assembly 222 is configured to permit the flow of gas to be directed into the bladder 220 through a fluid bladder conduit 230 in fluid communication with an interior of the bladder 220. Further, the one-way check valve of the check valve assembly 222 is configured to prevent gas from leaving the bladder 220 even when the handle assembly conduit 212 is detached from the check valve assembly 222. However, when actuated, the relief valve 224 permits gas to escape the bladder 220 through the fluid bladder conduit 230 and through the relief valve 224, so the one-way check valve of the check valve assembly 222 and the relief valve 224 are both in fluid communication with the bladder 220 through the fluid bladder conduit 230.

In general, the embodiment of FIG. 7 may function in similar ways to the embodiment of FIGS. 1-6, although the embodiment of FIG. 7 may be more convenient in some applications such as smaller pipes or other openings, for example.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A deployable plug system comprising:
a handle assembly comprising a handle assembly conduit and a gas control valve, wherein the gas control valve is configured to receive pressurized gas from a source of pressurized gas and to control flow of gas from the source of pressurized gas to the handle assembly conduit; and
a bladder assembly comprising an inflatable bladder and a unitary check valve assembly, wherein the unitary check valve assembly is configured to be coupled detachably to the handle assembly conduit to receive the flow of gas from the source of pressurized gas when the check valve assembly is coupled detachably to the handle assembly conduit, wherein the unitary check valve assembly comprises a one-way check valve that allows pressurized gas from the handle assembly conduit to enter the bladder when the check valve assembly is coupled detachably to the handle assembly conduit but that does not allow gas to leave the bladder, and wherein the unitary check valve assembly comprises a relief valve to enable pressurized gas to escape the bladder.

2. The system of claim 1 wherein:
the handle assembly further comprises a handle assembly conduit connector in fluid communication with the handle assembly conduit; and
the bladder assembly further comprises a check valve assembly connector selectively connectable to the handle assembly conduit connector to couple detachably the check valve assembly to the handle assembly conduit.

3. The system of claim 2 wherein:
the handle assembly conduit connector comprises a slot and an aperture in fluid communication with the handle assembly conduit; and
the check valve assembly connector comprises a hose selectively connectable to the slot to communicate the pressurized gas from the handle assembly conduit to the bladder when the hose is coupled detachably to the slot with the hose in fluid communication with the aperture.

4. The system of claim 3 wherein the hose comprises a sealing body sized to slide into the slot and form a seal surrounding the aperture when the hose is in fluid communication with the aperture.

5. The system of claim 4, wherein the sealing body is a sealing ring.

6. The system of claim 4 further comprising a release rod slidingly affixed to the handle assembly and configured to push the sealing body out of the slot in response to sliding relative to the handle assembly.

7. The system of claim 3 wherein the handle assembly conduit connector and the check valve assembly connector are configured to permit the conduit to be attached to and detached from the check valve assembly by sliding the conduit connector relative to the check valve assembly.

8. The system of claim 2 wherein the handle assembly and the bladder assembly comprise interlocking features, separate from the handle assembly conduit connector and the check valve assembly connector, that hold in relative position independently of handle assembly conduit connector and of check valve assembly connector

9. The system of claim 8 wherein the interlocking features are configured to permit the handle assembly and the bladder assembly to be attached to and detached from each other by sliding one of the handle assembly and the bladder assembly relative to the other of the handle assembly and the bladder assembly.

10. The system of claim 2 further comprising a release rod comprising a rod trigger that, when pressed, detaches the check valve assembly from the conduit connector.

11. The system of claim 2 wherein the handle assembly conduit connector and the check valve assembly connector form a fluid conduit coupling.

12. The system of claim 11 wherein the fluid conduit coupling is configured to couple detachably the check valve assembly connector and the handle assembly conduit connector in response to sliding one of the handle assembly and the bladder assembly relative to the other of the handle assembly and the bladder assembly.

13. The system of claim 11 wherein the fluid conduit coupling is configured to couple detachably the check valve assembly connector and the handle assembly conduit connector in response to sliding one of the handle assembly and the bladder assembly relative to the other of the handle assembly and the bladder assembly in a direction generally parallel to a longitudinal axis of the handle assembly conduit.

14. The system of claim 11 wherein the fluid conduit coupling comprises a slidable release body configured to detach the check valve assembly connector and the handle assembly conduit connector from each other in response to sliding the slidable release body.

15. The system of claim 14 wherein the slidable release body is slidable in a direction generally parallel to a longitudinal axis of the handle assembly conduit to detach the check valve assembly connector and the handle assembly conduit connector from each other.

16. The system of claim 11 wherein the fluid conduit coupling is configured to hold the bladder assembly in a defined position relative to the handle assembly and independently of any other connectors when the check valve assembly connector is coupled detachably to the handle assembly conduit connector.

17. The system of claim 1 wherein the handle assembly further comprises a valve trigger configured to control the gas control valve to control the flow of gas from the source of pressurized gas to the handle assembly conduit.

18. The system of claim 1 wherein the one-way check valve and the relief valve are in fluid communication with the bladder through a common fluid bladder conduit.

19. The system of claim 1 wherein the source of pressurized gas is a pressurized-gas canister that can be coupled detachably to the handle assembly.

20. The system of claim 1 wherein the bladder is configured to expand in length and width when filled with pressurized gas.
